(19) United States
(12) Patent Application Publication
(10) Pub. No.: US 2014/0059864 A1
(43) Pub. Date: Mar. 6, 2014

(54) KNIFE

(71) Applicant: Florian SEGLER, Solingen (DE)

(72) Inventor: Florian SEGLER, Solingen (DE)

(21) Appl. No.: 14/014,552

(22) Filed: Aug. 30, 2013

(30) Foreign Application Priority Data
Sep. 4, 2012 (DE) 102012017431.4

(51) Int. Cl. B26B 1/08

(52) U.S. Cl. CPC B26B 1/08
USPC 30/162

(57) ABSTRACT

The invention relates to a knife comprising a housing (11) and an actuator (14) that can shift a blade holder (13) carrying a blade (47) in the housing (11) between at least one safety position and at least one cutting position, the blade holder (13) being tensioned by a spring (35).

The characterizing feature consists in the fact that the spring (35) is attached to the housing (11) and to a first entrainment formation (25), and that a second entrainment formation (46) is associated with the blade holder (13), which second entrainment formation can be releasably engaged with the first entrainment formation (25) such that the first entrainment formation (25) can be moved by the second entrainment formation (46) from the safety position to the cutting position by movement of the blade holder.

The invention relates to a knife.

A knife of this type is well-known from published prior use. It comprises a housing in which a blade holder is located. The blade holder can be moved between a safety position and a cutting position. The blade is inaccessible in the housing when in the safety position, and projects from the housing when in the cutting position. A spring is fastened to the housing and to the blade holder, and urges the blade holder for example into the safety position.

The blade holder is often removed from the housing in order to change blades. As this is done, the spring is frequently overstretched and thus destroyed.

The object of the invention is to create a knife that is allows the blade to be conveniently changed while preventing any damage to the spring.

This object is achieved by a knife as set forth in the features of claim 1.

The knife according to the invention comprises a housing provided with a blade holder. The blade holder can be moved between at least one safety position in which a blade supported in the blade holder is inaccessible in the housing, and at least one cutting position in which the blade holder is in a position in which the blade projects from the housing. The blade holder is located, for example, inside the housing. It can be for example slidable on guide faces of the housing.

A spring is attached to the housing and to a first entrainment formation. The term spring according to the invention can include any form of biasing element, such as for example a metal spring, gas cylinder, etc. This can refer, for example to a tension spring or a compression spring. The spring can be loaded for example by moving the blade holder from the safety position into the cutting position. Alternatively or additionally, the spring can be loaded by moving the actuator or the actuating component from a first position into a second position. The first position is, for example a rear position and the second position is, for example a front position.

Actuator as defined by the invention in the broadest sense refers to a device for moving the blade holder. For example, an actuating handle can be part of the actuator. The actuator can, for example comprise a motion-transmitting mechanism between the handle and the blade holder.

A second entrainment formation is associated with the blade holder or the actuator. The second entrainment formation is provided on or attached for example to the blade holder or the actuator, i.e. one part or more parts of the actuator. For example, the second entrainment formation is formed directly or indirectly on the blade holder or the actuator. The second entrainment formation can be moved in releasable contact with the first entrainment formation. The second entrainment formation is carried along whenever, for example the blade holder is moved from the safety position to the cutting position by moving the actuator from the unactuated position to the actuated position. The first entrainment formation is driven, for example by the second entrainment formation, and moved from the rear position to the front position, thereby tensioning the spring. The second entrainment formation that is in contact with the first entrainment formation is also loaded by the spring. If, for example the second entrainment formation is attached to the blade holder, the blade holder is forced by the spring, for example into the safety position. If the blade holder is fixed or coupled to the actuator, it is entrained thereby.

When a blade is changed, the blade holder can be removed, for example from the housing without the need for the spring to be disconnected, since the entrainment formations can be detached from each other. The blade holder is, for example removed from the housing together with the second entrainment formation, while the first entrainment formation remains in place in the housing with the spring.

In one embodiment, the first entrainment formation is associated with a slide that can shift between a rear position and a front position on a guide of the housing. The first entrainment formation is composed, for example of a pin. The pin projects, for example into the housing so as to enable it to come into contact with the second entrainment formation when moved from the rear position to the front position and carry this element along.

The guide of the slide comprises, for example a first guide on the housing and a second guide on the slide. The first guide is formed for example by a groove or a slot. The second guide is provided, for example by a guide structure of the slide.

The second guide is provided, for example by the first entrainment formation.

In one embodiment of the invention, the blade is retained in a blade seat between a first support face of the blade holder and a second support face of a retaining element. The retaining element can be moved, for example between a retaining position and a release position. In the retaining position, the blade is retained by a nonpositive and/or positive clamp between the first supporting face and the second supporting face. When in the release position, the retaining element can be moved away from the blade holder, thereby enabling the blade to be removed from the blade seat.

Together with the blade holder, the retaining element creates, for example a pivot joint. The pivot joint can, for example be at a first end region of the blade holder and of the retaining element. The blade can be retained, for example in the blade seat at a second end region of the blade holder and of the retaining element.

The retaining element for example forms the actuator. The housing here is formed with a groove through which the retaining element passes. A ridge of the actuator, for example passes through the groove.

Unwanted movement of the retaining element from the retaining position to the release position can be prevented by an approach whereby the retaining element includes at least one arm that grips under the adjacent side wall of the housing. The retaining element is retained on the blade holder, for example by a pivot joint and additionally by the arm, the arm precluding any unwanted movement by the retaining element between the retaining position and the release position. The retaining element can then be moved into the release position, whenever the assembly unit consisting of the blade holder and actuator is removed from the housing.

Additional advantages are described in the following with reference to an embodiment shown in the figures. Therein:

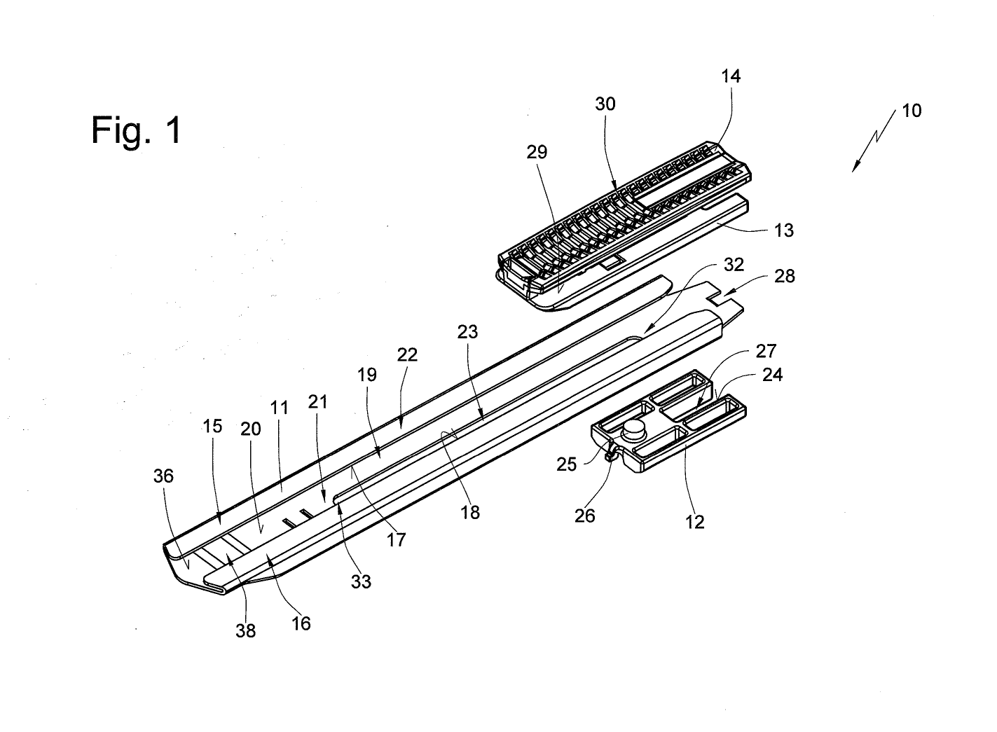

FIG. 1 is an exploded view of the knife comprising a housing, a spring slide, a blade holder, and an actuator.

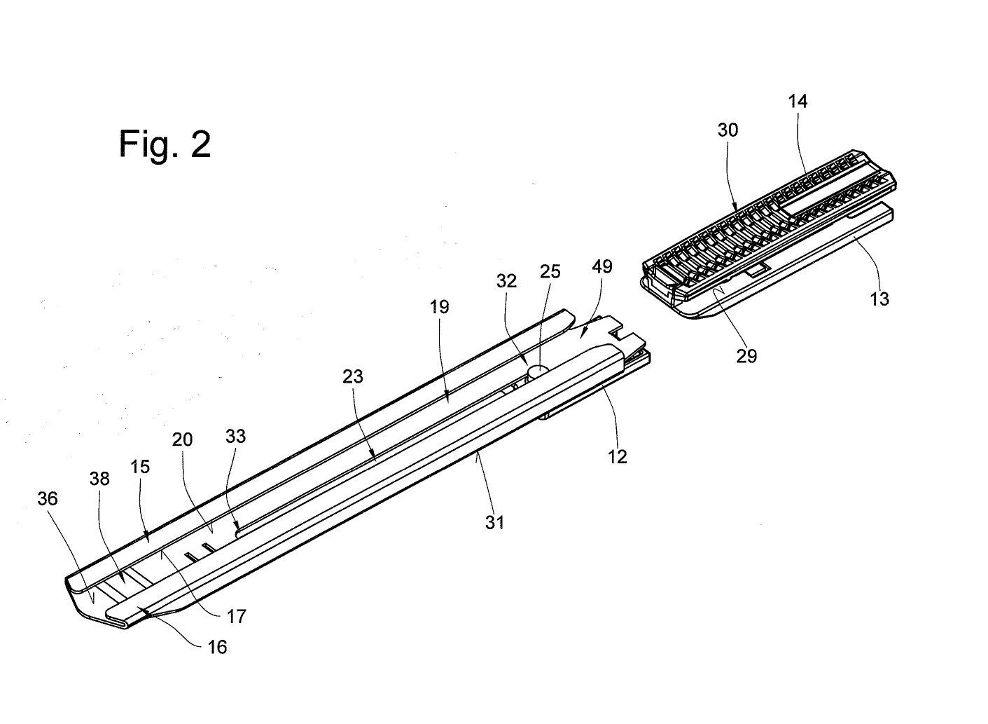

FIG. 2 is a detail from the exploded view of the knife with the spring slide installed on the housing.

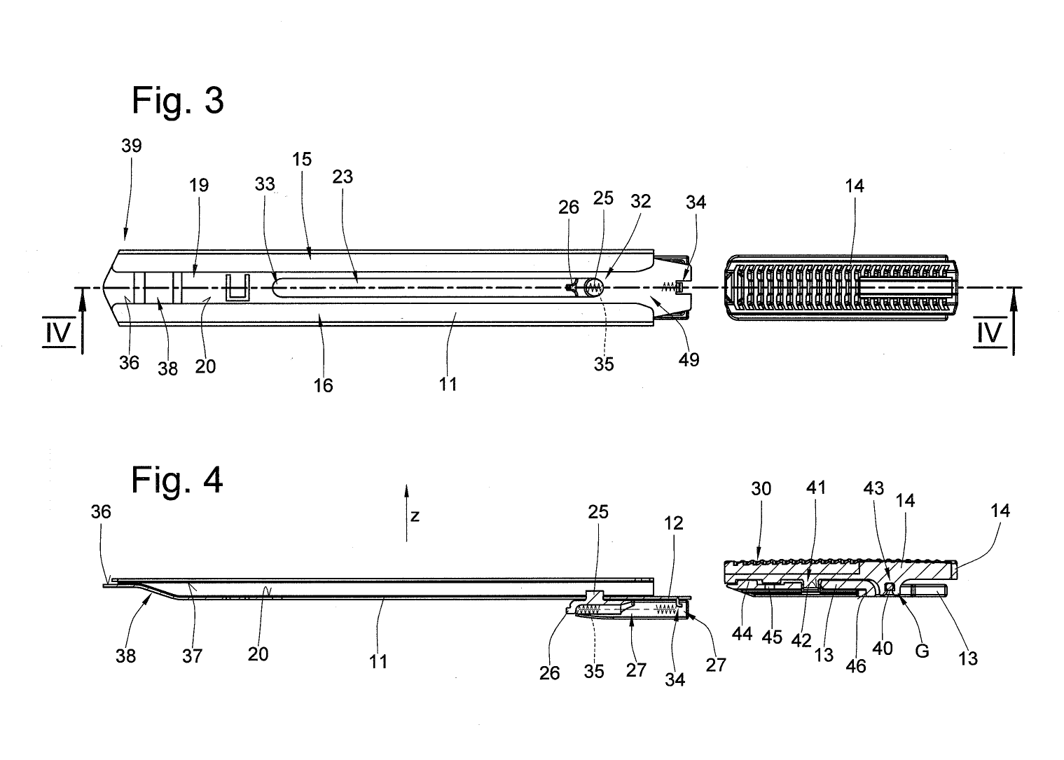

FIG. 3 is a top view of a first side of the knife with the blade holder and the actuator not installed.

FIG. 4 is a section along line IV-IV in FIG. 3.

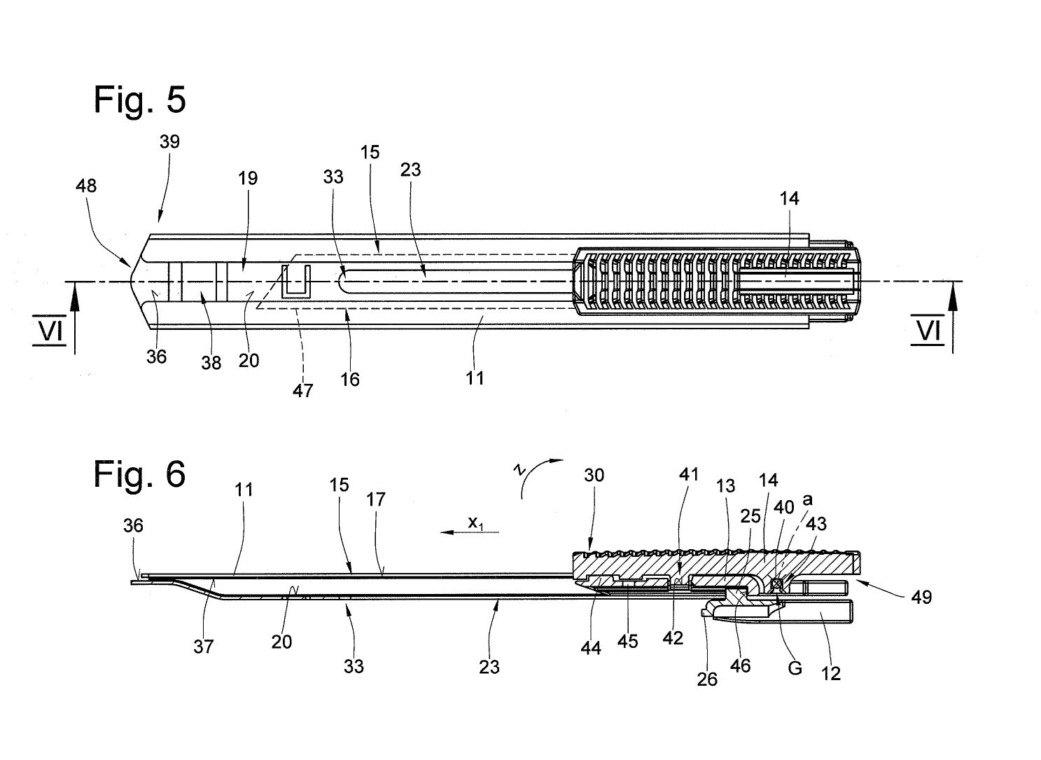

FIG. 5 is a top view of a first side of the knife with the blade holder and the actuator installed and the knife in the safety position.

FIG. 6 is a section along line VI-VI in FIG. 5.

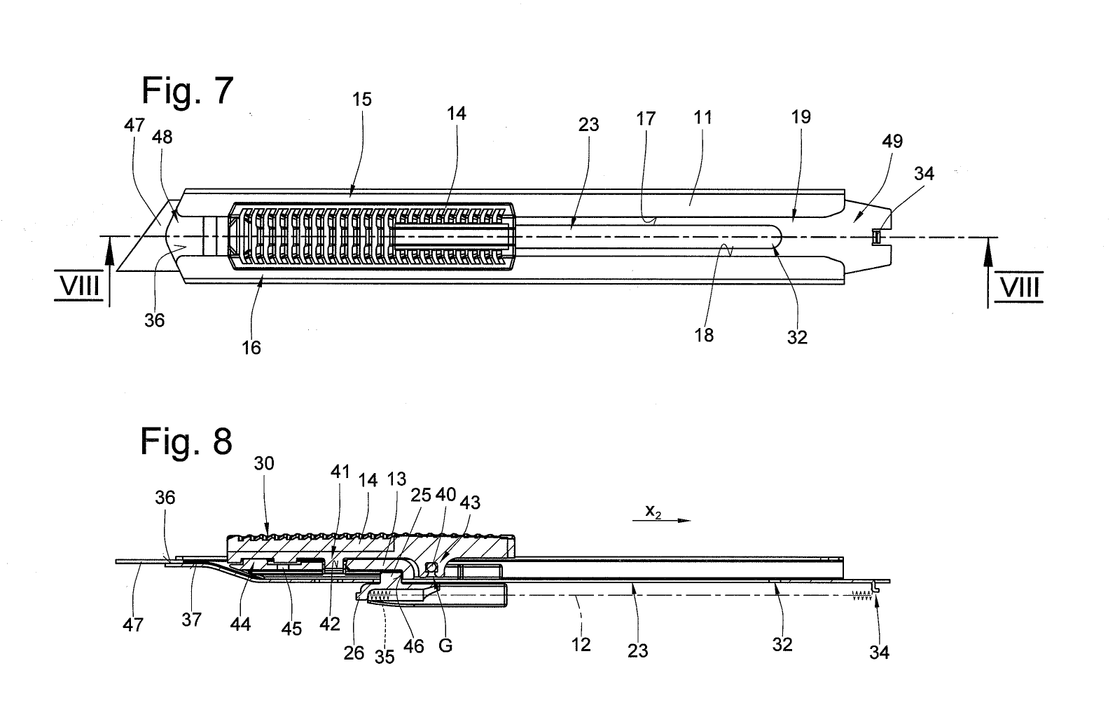

FIG. 7 is a top view of the knife as in FIG. 5 with the knife in the cutting position.

FIG. 8 is a section along line VIII-VIII in FIG. 7.

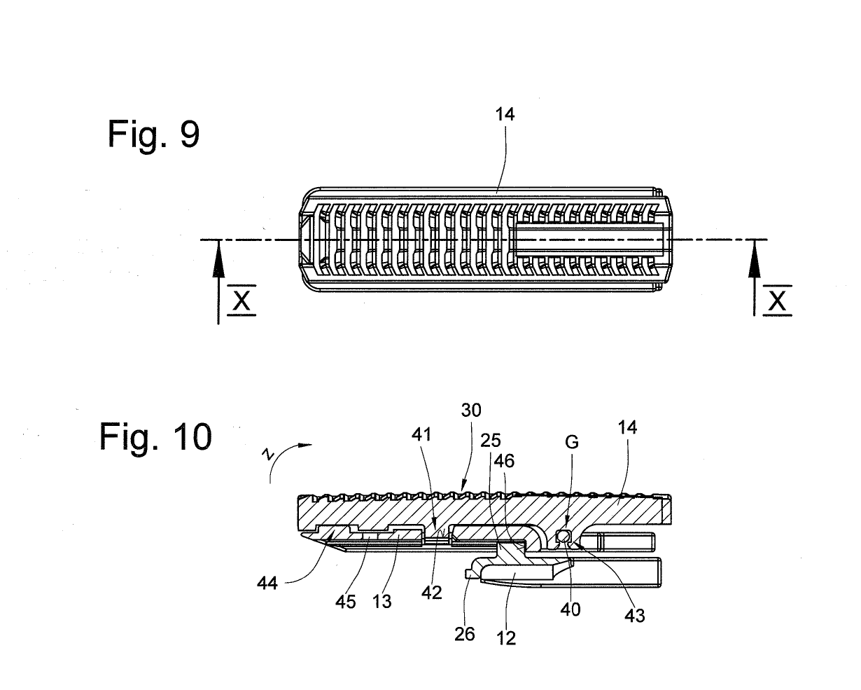

FIG. 9 is a schematic top view of the blade holder and actuator.

FIG. 10 is a section along line X-X in FIG. 9.

The knife as a whole is identified at 10 in the figures. Identical reference numerals in the various figures identify corresponding parts, including where lower-case letters have been added or omitted.

FIG. 1 shows that the knife 10 comprises a housing 11, a spring slide, 12, a blade holder 13, and also an actuator 14.

The housing 11 in this embodiment is made of sheet metal. Side flaps 15 and 16 are provided on the housing 11 that are folded over such that edges 17 and 15 of these flaps point toward each other and create guide surfaces. A groove 19 is formed between the edges 17 and 18. A floor surface 20 is formed by a floor wall 21 of the housing 11. The floor wall 21 is located opposite a top wall 22 formed by the side flaps 15 and 16. A blade, not shown, is located between the floor surface 20 and the side flaps 15 and 16. A slot 23 is formed in the floor wall 21. A tongue is cut out of a rear end 28 of the housing 11 and is folded over. The tongue is not shown in FIG. 1.

The spring slide 12 has a slide face 24. In addition, the spring slide 12 is formed with an entrainment pin 25 as well as a spring hook 26. The spring slide 12 is formed with a recess 27 on a side opposite the slide face 24.

The blade holder 13 is has a face forms a blade seat 29. The blade, which is not shown in FIG. 1, is retained between the blade holder and the actuator. The actuator 14 is provided with ridge formations 30 that prevents the fingers of user from sliding off.

FIG. 2 illustrates the spring slide 12 in the installed position. Slide face 24 rests against an outer face 31 of the floor wall 21. The entrainment pin 25 passes through the slot 23. This limits the movement of the spring slide 12. In the rear position of FIG. 2, the entrainment pin 25 is at a rear end 32 of the slot 23. When in the front position, the entrainment pin 25 is disposed at a front end 33 of the slot 23.

FIG. 3 shows the tongue 34 at the rear end 28 of the housing 11. One end of the above-mentioned spring 35 is fastened to the tongue 34. Another end is retained on the spring hook 26 of the spring slide 12.

A front end 39 of the housing 11 includes a guide surface 36 that is joined to the floor by an angled wall region 38. The guide surface 36 is at a spacing from lower faces 37 of the side flaps 15 and 16 that is less than their spacing from the floor surface 20. The blade holder 13 and the blade (not shown in FIG. 4) can thus be slide between the faces 37 and the floor surface 20 when shifting the safety position and the cutting position.

FIG. 4 shows that a pivot pin 40 is provided on the blade holder 13 that locks into a bearing seat 43 of the actuator 14. As a result, the blade holder 13 forms a pivot joint G with a pivot point a. Hook-shaped arms 41 including retaining faces 42 are provided on the actuator. When the blade holder 13 and the actuator 14 are installed, the arms 41 grip under the side flaps 15 and 16 so as to prevent the actuator from being pivoted in a direction z out of a retaining position into a release position.

The blade seat 29 comprises a stud 44 that passes through and fits with a correspondingly shaped hole in the blade and thus retains the blade in a positive-locking manner in the blade seat. In addition, the blade seat 29 is formed with a recess in which a magnet 45 is installed to make the blade cling to the blade seat 29. The bottom of the blade holder 13 forms an entrainment face 46.

The blade holder in FIG. 5 is in the safety position. A blade 47, which is shown only in outline in FIG. 5, is supported in the housing 11 in such a way that the cutting edge of blade 47 is inaccessible to the user as a result of being covered by the side flaps 15 and/or 16. When the assembly comprised of the actuator 14, the blade holder 13, and the blade 47 is moved in direction x1, the entrainment face 46 of the blade holder 13 makes contact with the entrainment pin 25 and thereby moves the spring slide 12 in the direction x1. This action tensions the spring 35. Movement of the actuator 14 in the direction x1 is possible only up until the entrainment pin 25 strikes the front end 33 of the slot 23. The blade holder is then located in the front cutting position in which the blade projects by the maximum amount from a front opening 48 of the housing 11.

When the user releases the actuator 14, the spring slide 12 is pulled in the direction x2 by the spring 35, while at the same time the blade holder 13 and the actuator 14 are also moved in the direction x2 by the entrainment pin 25 and the entrainment face 46.

The housing 11 comprises a cap, not shown, by which a rear opening 49 of the housing 11 can be closed and opened. In order to change the blade, the cap is opened, and the assembly unit comprising the blade holder 13, the actuator 14, and blade 47 are extracted from rear opening 49 of the housing 11.

At the point where supporting arms 41 are no longer able to grip under the side flaps 15 and 16, the actuator 14 can be pivoted about the pivot point a away from the blade holder 13 in pivot direction z1 into the release position, thereby allowing the blade 13 to be removed from the blade seat and a new blade to be inserted into the blade seat. The actuator is then pivoted back into the retaining position, and the assembly unit consisting of blade, the blade holder 13, and the actuator 14 is inserted into the housing 11. The closure, not shown, is then closed. The knife is then once again functionally ready for cutting.

1. A knife comprising a housing (11) and an actuator (14), wherein a blade holder (13) carrying a blade (47) can be shifted by the actuator (14) between at least one safety position and at least one cutting position, the blade (47) on the blade holder (13) being inside the housing (11) in the safety position, and projecting from the housing (11) in the cutting position, the blade holder (13) being biased by a spring (35), characterized in that the spring (35) is attached to the housing (11) and to a first entrainment formation (25), and that a second entrainment formation (46) is provided on the blade holder (13) or the actuator (14), the second entrainment formation being releasably engageable with the first entrainment formation (25) such that the first entrainment formation (25) is moved by the second entrainment formation (46).

2. The knife according to claim 1, characterized in that the blade holder (13) is urged by the spring (35) into the safety position.

3. The knife according to claim 1, characterized in that the first entrainment formation is associated with a slide (12) that is movably held in a guide on the housing (11) between a rear position and a front position.

4. The knife according to claim 3, characterized in that the guide comprises a first guide (23) associated with the housing (11) and second guide associated with the slide (12).

5. The knife according to claim 4, characterized in that the second guide is formed by the first entrainment formation (25).

6. The knife according to claim 1, characterized in that the blade (47) is retained between a supporting face of the blade holder (13) and a supporting face of a retaining element (14).

7. The knife according to claim 6, characterized in that the retaining element (14) is connected by a pivot joint (G) with the blade holder (13).

8. The knife according to claim 6, characterized in that the housing (11) includes a groove (19) through which the retaining element (14) passes.

9. The knife according to claim 6, characterized in that the retaining element (14) forms the actuator (14).

10. The knife according to claim 8, characterized in that the retaining element includes at least one arm (41) that grips under side flaps (15, 16) of the housing (11) defining the groove (19).
